(19) United States
(12) Patent Application Publication
(10) Pub. No.: US 2007/0025660 A1
(43) Pub. Date: Feb. 1, 2007

(54) All-optical variable optical attenuator

(76) Inventors: Su-Nam Lee, Gwangju Metropolitan City (KR); Se-Ho Lee, Gwangju Metropolitan City (KR); Ki-Ho Park, Gyeongsangnam-do (KR); Seong-Jae Boo, Gyeonggi-do (KR)

Correspondence Address: HARNESS, DICKEY & PIERCE, P.L.C., P.O. BOX 828, BLOOMFIELD HILLS, MI, 48303, US

(21) Appl. No.: 11/193,669

(22) Filed: Jul. 29, 2005

(51) Int. Cl. G02B 6/34; H04J 14/02

(52) U.S. Cl. 385/37; 385/31; 385/140; 385/141; 385/142; 398/43; 398/82; 398/87

(57) ABSTRACT

Disclosed is an all-optical variable optical attenuator. The all-optical variable optical attenuator includes a nonlinear optical fiber where a pair of long-period gratings is formed in a pre-determined pattern. Alternatively, the variable optical attenuator may include a pair of optical fibers where a long-period grating is formed in each optical fiber in a pre-determined pattern to form a pair of long-period gratings on the whole, and a nonlinear optical fiber fusion-spliced between one ends of the respective optical fibers. The core layer of the nonlinear optical fiber contains semiconductor particles having a size of nanometers, a metallic particle having a size of nanometers, or a rare-earth element.

### BACKGROUND OF THE INVENTION

1. Field of the Invention

The present invention relates to an all-optical variable optical attenuator. More specifically, the invention relates to such an optical attenuator, in which characteristics of a nonlinear optical fiber and those of a long-period grating pair or a short-period grating are utilized to adjust light attenuation in an all-optical fashion.

2. Background of the Related Art

An optical attenuator is described by a manual optical element for causing a certain amount of light loss to the intensity of incident light to thereby emitting an attenuated light. Mostly, the optical attenuator functions to adjust the light intensity of incident light to an optimal value in a light-receiving element. For a long-range transmission in an optical system, the higher light output is necessitated, but, in a light-receiving element, an appropriate intensity of input signal is required. Thus, the optical attenuator performs this function and is categorized into a fixed type and a variable type. The variable type optical attenuator can control the degree of attenuation of optical signals in an electrical or mechanical manner. The optical attenuator carries out various functions, such as a characteristic analysis of light intensity in a system or element, or an optical cross-connection based on wavelength division multiplex (WDM). In a transmission and transfer network based on the WDM, a plurality of wavelengths is multiplexed and transmitted and the light intensity must be uniformly maintained with respect to the respective wavelengths. During the processing of optical signals, however, the amplification and loss characteristics become different from a wavelength to a wavelength. Thus, the intensity of output light must be uniformized for the respective wavelengths. As such, a variable optical attenuator is necessitated to easily control the degree of attenuation externally. In addition, since multi-wavelengths must be simultaneously processed in a parallel mode, plural optical attenuators must be easily integrated structurally in parallel.

In the optical attenuators used in optical fibers, generally, the attenuation may be performed mechanically, or may be performed by applying an electric power. FIG. 1 shows a conventional mechanical-type variable optical attenuator. As shown in FIG. 1, the mechanical-type optical attenuator uses an optical collimator, in which lenses 12 and 13 are attached to the terminal ends of optical fibers 11 and 14 such that parallel light rays can be emitted to the air from the optical fiber. Conversely, parallel incident light may be collected into the inside of the optical fiber. A completely opaque object 15 is interposed between two optical collimators facing each other in a straight light axis. Then, the object 15 is rotated or moved to thereby block appropriately the light quantity passing in parallel between the two optical collimators and thus adjust the light intensity. In this method, however, it takes a few seconds for the light quantity to be converted into a maximum value from a minimum value, i.e., very slowly converted. In addition, due to a motor for rotating the opaque object, the entire volume thereof is increased.

FIG. 2 shows a conventional electrical-type variable optical attenuator where an electric power is applied to heat. As shown in FIG. 2, heat is applied to the light waveguide to change refraction index. Two optical waveguides are fabricated on a silicon wafer so as to be adjacent to each other, using silica, polymer or the like, and a heater is formed thereabove. When an electric power is applied to heat the heater, the surrounding temperature is increased. At this time, the refraction index of the wave guide is changed and thus the coupling degree between the neighboring wave guides Thus, the light is transferred between neighboring waveguides (B→B*) and thus the light quantity between input and output can be adjusted (A→A*). In this method, also, the manufacturing cost of the optical waveguide is significant, and a process for connecting the optical waveguide with the optical fiber is required. In addition, the coupling degree between the two waveguides rely on wavelength, thus leading to a degraded wavelength reliability.

As described above, the conventional electrical- and mechanical-type variable optical attenuator is not satisfactory in terms of the accuracy, reliability, economical efficiency, and the like.

### SUMMARY OF THE INVENTION

Therefore, the present invention has been made in view of the above problems, and it is an object of the present invention to provide a novel all-optical variable optical attenuator having a good accuracy, reliability and economical efficiency, as compared with the conventional mechanical- and electrical-type variable optical attenuator.

To accomplish the above object, according to one aspect of the present invention, there is provided an all-optical variable optical attenuator comprising a non-linear optical fiber where a pair of long-period gratings is formed in a pre-determined pattern, wherein the core layer of the nonlinear optical fiber contains semiconductor particles having a size of nanometers, a metallic particle having a size of nanometers, or a rare-earth element.

Preferably, the semiconductor particle is selected from the group consisting of PbTe, PbS, PbSe, SnTe, CuCl, CdS, and CdSe.

Preferably, the metallic particles are selected from the group consisting of Au, Ag, and Cu.

Preferably, the rare-earth element is selected from the group consisting of Er, Nd, Yb, Tb, Pr, Eu, Dy, Tm, Ho, and Sm.

According to another aspect of the invention, there is provided an all-optical variable optical attenuator comprising: a pair of optical fibers where a long-period grating is formed in each optical fiber in a pre-determined pattern to form a pair of long-period gratings on the whole; and a nonlinear optical fiber fused between one ends of the respective optical fibers, wherein the core layer of the nonlinear optical fiber contains semiconductor particles having a size of nanometers, a metallic particle having a size of nanometers, or a rare-earth element.

Preferably, the semiconductor particle is selected from the group consisting of PbTe, PbS, PbSe, SnTe, CuCl, CdS, and CdSe.

Preferably, the metallic particles are selected from the group consisting of Au, Ag, and Cu.

Preferably, the rare-earth element is selected from the group consisting of Er, Nd, Yb, Tb, Pr, Eu, Dy, Tm, Ho, and Sm.

According to another aspect of the invention, there is provided an all-optical variable optical attenuator comprising: an optical fiber where a short-period grating is formed in a pre-determined pattern; and a nonlinear optical fiber fused to one end of the optical fiber, wherein the core layer of the nonlinear optical fiber contains semiconductor particles having a size of nanometers, a metallic particle having a size of nanometers, or a rare-earth element.

Preferably, the semiconductor particle is selected from the group consisting of PbTe, PbS, PbSe, SnTe, CuCl, CdS, and CdSe.

Preferably, the metallic particles are selected from the group consisting of Au, Ag, and Cu.

Preferably, the rare-earth element is selected from the group consisting of Er, Nd, Yb, Tb, Pr, Eu, Dy, Tm, Ho, and Sm.

According to another aspect of the invention, there is provided an all-optical variable optical attenuator comprising a nonlinear optical fiber where a short-period grating is formed in a pre-determined pattern, wherein the core layer of the non-linear contains a semiconductor particle having a size of nanometers, a metallic particle having a size of nanometers, or a rare-earth element.

Preferably, the semiconductor particle is selected from the group consisting of PbTe, PbS, PbSe, SnTe, CuCl, CdS, and CdSe.

Preferably, the metallic particles are selected from the group consisting of Au, Ag, and Cu.

Preferably, the rare-earth element is selected from the group consisting of Er, Nd, Yb, Tb, Pr, Eu, Dy, Tm, Ho, and Sm.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 shows a conventional mechanical-type variable optical attenuator;

FIG. 2 shows a conventional electrical-type variable optical attenuator;

FIG. 3 conceptually illustrates a variable optical attenuator according to a first embodiment of the invention where a nonlinear optical fiber is fusion-spliced between a pair of optical fibers having a long-period grating formed therein;

FIG. 4 conceptually illustrates a variable optical attenuator according to a second embodiment of the invention where a long-period grating pair is formed along a nonlinear optical fiber;

FIG. 5 conceptually illustrates a variable optical attenuator according to a third embodiment of the invention where a nonlinear optical fiber is fusion-spliced to an optical fiber having an FBG (Fiber Bragg Grating) formed therein;

FIG. 7 shows a movement in a light inference pattern with the intensity of LD pumping light in a variable optical attenuator according to the invention where a nonlinear optical fiber is fusion-spliced between a pair of optical fibers having a long-period grating formed therein; and

FIG. 8 shows a change in a light transmissivity with the intensity of LD pumping light in a variable optical attenuator according to the invention where a nonlinear optical fiber is fusion-spliced between a pair of optical fibers having a long-period grating formed therein.

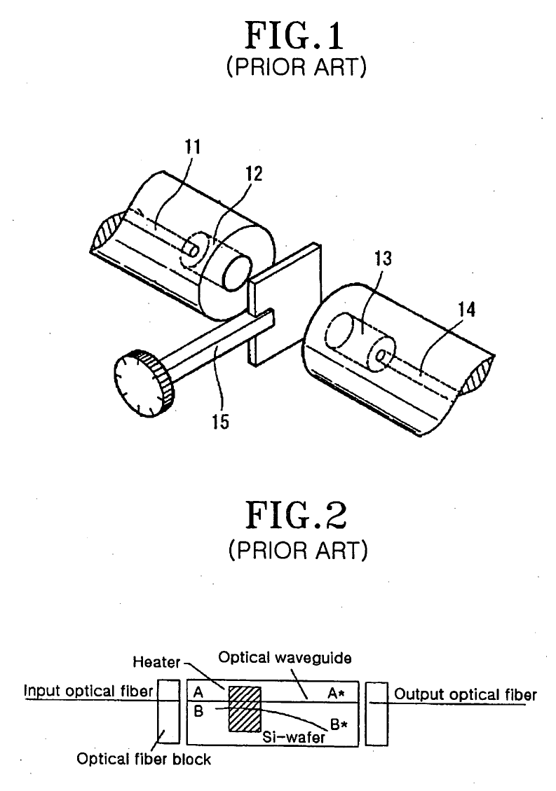

### DETAILED DESCRIPTION OF THE PREFERRED EMBODIMENT

The preferred embodiments of the invention will be hereafter described in detail, with reference to the accompanying drawings.

According to one of major features of the invention, a nonlinear optical fiber is interposed between long-period gratings. Thus, when pumping light is incident using a laser diode, the nonlinear optical fiber has different refractive index depending on the pumping light, dissimilar to a common optical fiber, i.e., the optical signal travelling path is lengthened. Thus, a light interference pattern generated by a long-period grating is moved to the long wavelength side. Accordingly, as the intensity of pumping light varies, the change in the refraction index varies. Consequently, the light transmissivity at a certain specific wavelength, for example, 1550 nm, changes.

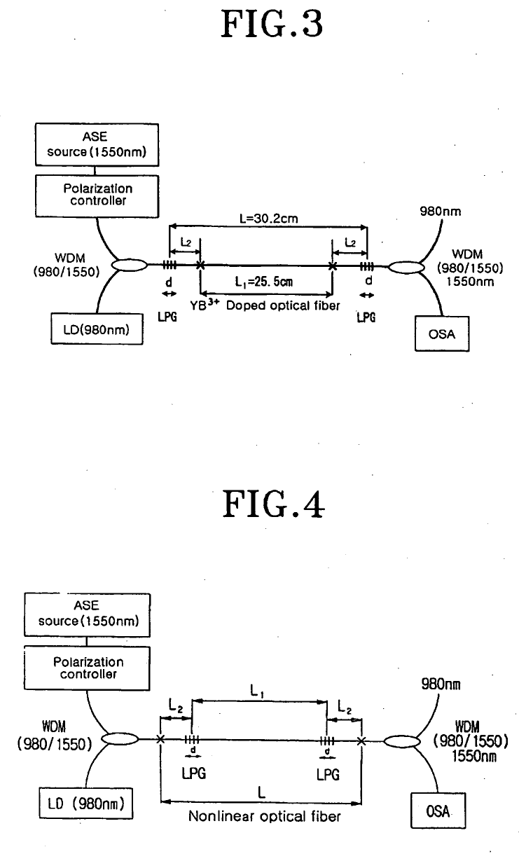

FIG. 3 conceptually illustrates a variable optical attenuator according to a first embodiment of the invention where a non-linear optical fiber is fused between a pair of optical fibers having a long-period grating formed therein. Referring to FIG. 3, when the intensity of pumping light is changed from 0 mW to 35 mW, the light is attenuated from 0 dB to 20 dB. Since a commercial laser diode can output up to about 500 mW, it is found out that the above change is performed through a small power value.

In the long-period grating, part of optical signal travelling thereon is lost to the cladding, so that the light transmissivity is drastically decreased at a certain specific wavelength. In the present invention, one long-period grating is further provided to form a pair of long-period gratings and thus a cladding mode is coupled to a core mode through one of the long-period gratings. Thus, light transmissivity is changed into a wideband erase form. Thereafter, the cladding mode is coupled into a core mode again through the other long-period gratings, and thus, due to interference between the two modes, a light interference pattern divided into plural patterns is exhibited. As can be seen in FIG. 8, plural patterns are exhibited in a narrow range of wavelength. Since a wideband erase occurs in a narrow range of wavelength, a slight movement in the light interference pattern leads to a large change in the light transmissivity. Consequently, even if the intensity of pumping light is made small, intended light attenuation can be easily achieved. That is, the reason for using the pair of long-period gratings is to broaden the width of light attenuation at a low intensity of pumping light.

According to another feature of the invention, a short-period grating may be used instead of the long-period grating pair. The short-period of grating is also known as a fiber Bragg grating (FBG), which is more popularly used. The FBG has a grating period of 0.3˜0.5 μm, which is much less than that of a long-period grating, i.e., 0.3˜0.5 mm (about one thousandth). Dissimilar to the long-period grating, optical signals passing through the core of the FBG is reflected, i.e., does not pass the core and cladding and thus the light transmissivity changes. In this case, a pair of gratings is not necessitated, but one grating may be used. As an advantage of the FBG, reflectivity can be made up to above 99.9% at maximum. That is, at a certain specific wavelength, the intensity of light can be significantly reduced through reflection. Thus, the change in light transmissivity can be easily made up to around 40 dB. Also, if the intensity of pumping light in the laser diode varies, the light transmission spectrum (changed by reflection) can be shifted, and a change in light transmissivity can be derived to perform the function of a variable optical attenuator.

As described above, the FBG is more favorable relative to the long-period grating. In the case of the long-period grating, the grating formation time is disadvantageously increased in order to change up to around 40 dB. In the case of the FBG, the range of optical attenuation can be easily increased up to 40 dB in terms of processing, and also the line width of light transmission spectrum can be easily adjusted advantageously.

### EXAMPLES 1 AND 2

As a characteristic of optically nonlinear optical fiber, its refractive index and thus resultant transmission characteristics vary with the intensity of pumping. As a characteristic of a long-period grating, in the case where a grating is formed in an optical fiber, part of incident light is coupled into a cladding mode to cause light loss.

In this way, a nonlinear optical fiber is connected with an optical fiber having a long-period grating formed therein, or a long-period grating is formed directly in a nonlinear optical fiber, thus enabling to fabricate a novel all-optical variable optical attenuator by moving loss spectrum of optical signals depending on the intensity of LD (laser diode) pumping.

First, referring to FIG. 3, the first embodiment of the invention will be explained. In this embodiment, L=30,5 cm, L₁=25.5 cm, L₂=2.5 cm, and d=0.5˜1 cm. In this embodiment, an Yb-doped optical fiber was used. The Yb-doped optical fiber is one of non-linear optical fibers and is connected between a pair of long-period gratings through a fusion bonding.

FIG. 4 conceptually illustrates a variable optical attenuator according to a second embodiment of the invention where a long-period grating pair is formed along a nonlinear optical fiber. Referring to FIG. 4, the second embodiment of the invention will be explained. In this embodiment, L, L₁, L₂ and d are made to be the same as the first embodiment. Ultraviolet rays are exposed to the core of a nonlinear optical fiber containing Ge to thereby directly form a long-period grating.

A core layer of the nonlinear optical fiber that is used in Examples 1 and 2, contains semiconductor particles having a size of nanometers, a metallic particle having a size of nanometers, or a rare-earth element. Preferably, the semiconductor particle is selected from the group consisting of PbTe, PbS, PbSe, SnTe, CuCl, CdS, and CdSe. Preferably, the metallic particles are selected from the group consisting of Au, Ag, and Cu. Preferably, the rare-earth element is selected from the group consisting of Er, Nd, Yb, Tb, Pr, Eu, Dy, Tm, Ho, and Sm.

In the all-optical variable optical attenuators according to the first and second embodiments of the invention, if a pumping is carried out while increasing the optical power from 0 mW to 56 mW through a WDM coupler using a laser diode of wavelength of 980 nm, optical signals incident on the ASE generates a light interference pattern (a periodic change in light transmission or light absorption with wavelengths) by the two long-period gratings and the light interference pattern is moved to a long wavelength side (see FIG. 8). At this time, the movement in the light interference pattern is measured through the right OSA. If a change in the moved light transmissivity is measured at a certain constant wavelength, a change in the light transmissivity according to the optical power of the laser diode, i.e., a change in light attenuation (dB) can be obtained (refer to FIG. 8).

Consequently, with the variable optical attenuator having the construction of FIG. 3, if the power of the laser diode is changed, a light attenuation can be achieved at the original optical signal (near 1550 nm in FIG. 8).

In FIG. 8, a desired wavelength can be selected to draw the change in light transmission, and four wavelengths are selected to show all together. One or more desired wavelengths may be selected.

Here, since the ASE generates an optical signal of 1550 nm-wavelength range, only a light interference pattern near 1550 nm is obtained. In a case of generating an optical signal of 1310 nm-wavelength range, a light interference pattern at 1310 nm. If the intensity of LD pumping light varies, a variable light attenuation can be performed at corresponding wavelengths.

### EXAMPLES 3 AND 4

As a characteristic of optically nonlinear optical fiber, its refractive index and thus resultant transmission characteristics vary with the intensity of pumping. As a characteristic of a short-period grating, an optical signal passing through the core is reflected to thereby cause a change in light transmissivity (not passing the core and the cladding).

In this way, a nonlinear optical fiber is connected with an optical fiber having a short-period grating formed therein, or a short-period grating is formed directly in a nonlinear optical fiber, thus enabling to fabricate a novel all-optical variable optical attenuator by moving loss spectrum of optical signals depending on the intensity of LD (laser diode) pumping.

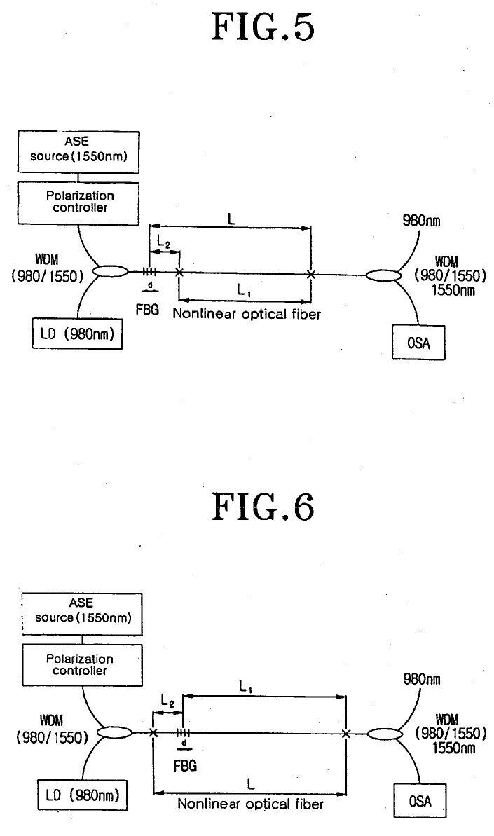

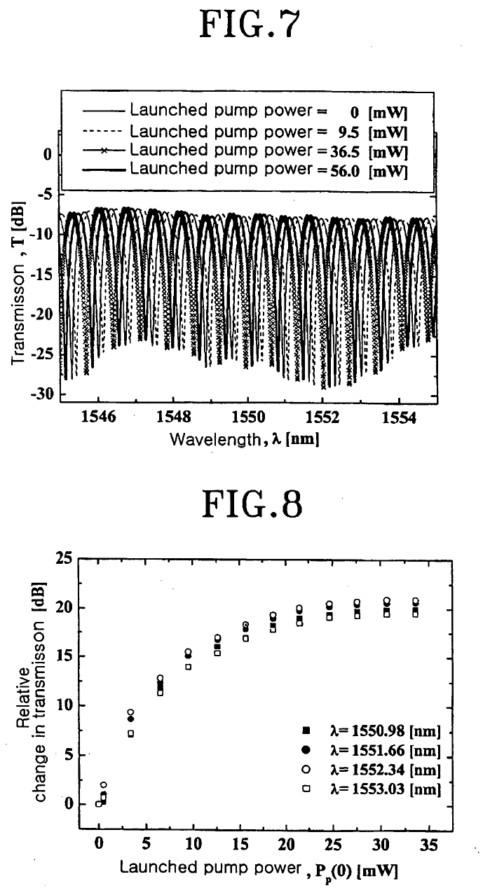

First, FIG. 5 conceptually illustrates a variable optical attenuator according to a third embodiment of the invention where a nonlinear optical fiber is fusion-spliced to an optical fiber having an FBG formed therein. Referring to FIG. 5, the third embodiment of the invention will be explained. In this embodiment, L=28 cm, L₁=25.5 cm, L₂=2.5 cm, and d=0.5˜1 ccm. In this embodiment, an Yb-doped optical fiber was used. The Yb-doped optical fiber is one of nonlinear optical fibers and is fusion-spliced to one end of an optical fiber having a short-period grating formed therein.

FIG. 6 conceptually illustrates a variable optical attenuator according to a fourth embodiment of the invention where an FBG is formed in a nonlinear optical fiber. Referring to FIG. 6, the fourth embodiment of the invention will be explained. In this embodiment, L, L₁, L₂ and d are made to be the same as the third embodiment. Ultraviolet rays are exposed to the core of a non-linear optical fiber containing Ge to thereby directly form a short-period grating.

A core layer of the nonlinear optical fiber that is used in Examples 3 and 4, contains semiconductor particles having a size of nanometers, a metallic particle having a size of nanometers, or a rare-earth element. Preferably, the semiconductor particle is selected from the group consisting of PbTe, PbS, PbSe, SnTe, CuCl, CdS, and CdSe. Preferably, the metallic particles are selected from the group consisting of Au, Ag, and Cu. Preferably, the rare-earth element is selected from the group consisting of Er, Nd, Yb, Tb, Pr, Eu, Dy, Tm, Ho, and Sm.

In the all-optical variable optical attenuators according to the third and fourth embodiments of the invention, reflectivity can be made up to above 99.9% at maximum. That is, at a certain specific wavelength, the intensity of light can be significantly reduced through reflection. Thus, the change in light transmission can be easily made up to around 40 dB. Also, if the intensity of pumping light in the laser diode varies, the light transmission spectrum (changed by reflection) can be shifted, and a change in light transmissivity can be derived to perform the function of a variable optical attenuator.

As described above, according to the present invention, a novel all-optical variable optical attenuator can be provided, which has a good accuracy, reliability and economical efficiency, as compared with the conventional mechanical- and electrical-type variable optical attenuator.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An all-optical variable optical attenuator comprising a nonlinear optical fiber where a pair of long-period gratings is formed in a pre-determined pattern, wherein the core layer of the nonlinear optical fiber contains semiconductor particles having a size of nanometers, a metallic particle having a size of nanometers, or a rare-earth element.

2. The variable optical attenuator according to claim 1, wherein the semiconductor particle is selected from the group consisting of PbTe, PbS, PbSe, SnTe, CuCl, CdS, and CdSe.

3. The variable optical attenuator according to claim 1, wherein the metallic particles are selected from the group consisting of Au, Ag, and Cu.

4. The variable optical attenuator according to claim 1, wherein the rare-earth element is selected from the group consisting of Er, Nd, Yb, Tb, Pr, Eu, Dy, Tm, Ho, and Sm.

5. An all-optical variable optical attenuator comprising:
a pair of optical fibers where a long-period grating is formed in each optical fiber in a pre-determined pattern to form a pair of long-period gratings on the whole; and
a nonlinear optical fiber fusion-spliced between one ends of the respective optical fibers, wherein the core layer of the nonlinear optical fiber contains semiconductor particles having a size of nanometers, a metallic particle having a size of nanometers, or a rare-earth element.

6. The variable optical attenuator according to claim 5, wherein the semiconductor particle is selected from the group consisting of PbTe, PbS, PbSe, SnTe, CuCl, CdS, and CdSe.

7. The variable optical attenuator according to claim 5, wherein the metallic particles are selected from the group consisting of Au, Ag, and Cu.

8. The variable optical attenuator according to claim 5, wherein the rare-earth element is selected from the group consisting of Er, Nd, Yb, Tb, Pr, Eu, Dy, Tm, Ho, and Sm.

9. An all-optical variable optical attenuator comprising:
an optical fiber where a short-period grating is formed in a pre-determined pattern; and
a nonlinear optical fiber fused to one end of the optical fiber,
wherein the core layer of the nonlinear optical fiber contains semiconductor particles having a size of nanometers, a metallic particle having a size of nanometers, or a rare-earth element.

10. The variable optical attenuator according to claim 9, wherein the semiconductor particle is selected from the group consisting of PbTe, PbS, PbSe, SnTe, CuCl, CdS, and CdSe.

11. The variable optical attenuator according to claim 9, wherein the metallic particles are selected from the group consisting of Au, Ag, and Cu.

12. The variable optical attenuator according to claim 9, wherein the rare-earth element is selected from the group consisting of Er, Nd, Yb, Tb, Pr, Eu, Dy, Tm, Ho, and Sm.

13. An all-optical variable optical attenuator comprising a nonlinear optical fiber where a short-period grating is formed in a pre-determined pattern, wherein the core layer of the nonlinear optical fiber contains semiconductor particles having a size of nanometers, a metallic particle having a size of nanometers, or a rare-earth element.

14. The variable optical attenuator according to claim 13, wherein the semiconductor particle is selected from the group consisting of PbTe, PbS, PbSe, SnTe, CuCl, CdS, and CdSe.

15. The variable optical attenuator according to claim 13, wherein the metallic particles are selected from the group consisting of Au, Ag, and Cu.

16. The variable optical attenuator according to claim 13, wherein the rare-earth element is selected from the group consisting of Er, Nd, Yb, Tb, Pr, Eu, Dy, Tm, Ho, and Sm.
